(19) United States
(12) Patent Application Publication
(10) Pub. No.: US 2023/0317918 A1
(43) Pub. Date: Oct. 5, 2023

(54) Electrically Conductive Substrate for an Electrochemical Device

(71) Applicant: II-VI Delaware, Inc., Wilmington, DE (US)

(72) Inventors: Wen-Qing Xu, Sarver, PA (US); Linze Du Hill, Pittsburgh, PA (US); Chengkun Xu, Valencia, PA (US); Zan Gao, Wexford, PA (US); Xinyu Lu, Wexford, PA (US); Christopher S. Koeppen, New Hope, PA (US)

(21) Appl. No.: 18/121,383

(22) Filed: Mar. 14, 2023

Related U.S. Application Data
(60) Provisional application No. 63/319,859, filed on Mar. 15, 2022.

(51) Int. Cl. H01M 4/62; H01M 4/133; H01M 4/136

(52) U.S. Cl. CPC H01M 4/136; H01M 4/133; H01M 4/622; H01M 2004/027

(57) ABSTRACT

An electrochemical device includes a first electrode having 50 wt.% to 99 wt.% immobilized sulfur, 1 wt. % to 12 wt.% binder, and 0.2 wt.% to 12 wt.% porous composition. The porous composition includes 0.0001 wt.% to 40 wt.% of a first porous material having an average pore size less of than 2 nm and 0.05 wt.% to 40 wt.% of a second porous material having an average pore size of 2 nm to 100 nm. The electrochemical device further includes a second electrode opposed from the first electrode and an electrolyte positioned between the first electrode and the second electrode.

### CROSS REFERENCE TO RELATED APPLICATIONS

This application claims the benefit of U.S. Provisional Pat. Application No. 63/319,859, filed Mar. 15, 2022, which is incorporated herein by reference in its entirety.

### TECHNICAL FIELD

The present application relates generally to electrically conductive materials and, more specifically, to electrically conductive substrates for electrochemical devices.

### BACKGROUND

Electrochemical devices, such as batteries, commonly use lithium as a storage medium. Rechargeable batteries require continuous ion transport across the materials used herein. Current drawbacks to alternative materials to lithium used in electrochemical devices include, among other things, susceptibility to cracking, peeling, decreased cycle rate, problems with adhesion, and poor performance.

Accordingly, those skilled in the art continue research and development in the field of materials used for electrically conductive substrates for electrochemical devices, and more particularly, for batteries.

### SUMMARY

Disclosed are electrochemical devices.

In one example, the electrochemical device includes a first electrode having 50 wt.% to 99 wt.% immobilized sulfur, 1 wt. % to 12 wt.% binder, and 0.2 wt.% to 12 wt.% porous composition. The porous composition includes 0.0001 wt.% to 40 wt.% of a first porous material 182 having an average pore size less of than 2 nm and 0.05 wt.% to 40 wt.% of a second porous material 184 having an average pore size of 2 nm to 100 nm. The electrochemical device further includes a second electrode opposed from the first electrode and an electrolyte positioned between the first electrode and the second electrode.

Also disclosed is an electrically conductive substrate for an electrochemical device.

In one example, the electrically conductive substrate for an electrochemical device includes 50 wt.% to 99 wt.% immobilized sulfur, 1 wt. % to 12 wt.% binder, and 0.2 wt.% to 12 wt.% porous composition. The porous composition includes 0.0001 wt.% to 40 wt.% of a first porous material 182 having an average pore size less of than 2 nm and 0.05 wt.% to 40 wt.% of a second porous material 184 having an average pore size of 2 nm to 100 nm.

Other examples will become apparent from the following detailed description, the accompanying drawings, and the appended claims.

### BRIEF DESCRIPTION OF THE DRAWINGS

The disclosure will be described with reference to the following drawing figures wherein like reference numbers identify like parts throughout.

FIG. 1 is a cross-sectional schematic of an electrochemical device;

FIG. 2 is an exploded schematic of an electrochemical device;

FIG. 3 is a graph illustrating pore size distribution of a first porous material 182;

FIG. 4 is a graph illustrating pore size distribution of a second porous material 184;

FIG. 5 is a graph illustrating pore size distribution of a third porous material 186;

FIG. 6 is a graph illustrating pore size distribution of a mixture of porous materials;

FIG. 7 is a graph illustrating pore size distribution of the mixture of porous materials of FIG. 6;

FIG. 8 is a scanning electron micrograph image of a mixture of porous materials;

FIG. 9 is scanning electron micrograph image of a porous material;

FIG. 10 is schematic diagram of a mixture of porous materials;

FIG. 11 is graph of the cycling performance of an electrochemical device;

FIG. 12 is graph of the cycling performance of an electrochemical device;

FIG. 13 is graph of the cycling performance of an electrochemical device;

FIG. 14 is graph of the cycling performance of two electrochemical devices;

FIG. 15 is graph of the cycling performance of an electrochemical device; and

FIG. 16 is a diagram of an electrically conductive substrate.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

In one aspect, disclosed herein are carbon-sulfur cathode materials that are formed with materials having different levels of porosity, with the understanding that selectively controlling the porosity in turn controls ion transport.

Using mixtures of materials having different distributions of carbon porosity, the following disclosure specifically exhibits their use in the formation of electrodes, such as cathodes, both “thin” cathodes (e.g., 0.64, 0.67, or 0.71 mg-S/cm²) and “thick” cathodes (e.g., 4.4 mg-S/cm²). The results as described below are associated with a specific configuration where an electrode comprises 10 wt.% binder material, approx. 80 wt.% immobilized sulfur (e.g., 64 wt.% sulfur and 36 wt.% carbon), and the balance comprising a conductive carbon of various one or more of the porosity levels defined above and discussed below. The remaining components may comprise any suitable prior art form, where an exemplary anode including lithium and a layer of a high-performance membrane material was used as separator.

A battery made with a thin carbon-based cathode of a singular porosity material did not cycle well. However, an improvement was recognized by using a thin cathode having an ion transport system including a mixture of materials having different porosity distributions, as further described in the following disclosure.

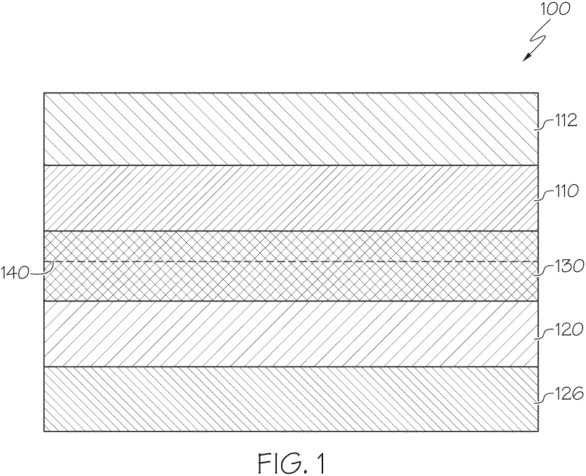

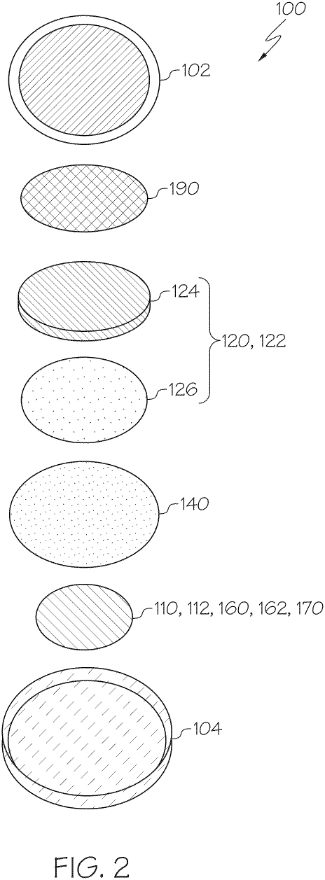

Referring to FIG. 1 and FIG. 2, disclosed is an electrochemical device 100, such as a battery, and more particularly a coin cell battery. In one example, the electrochemical device 100 includes a first electrode 110. The first electrode 110 may be defined as a cathode 112 or any other electrically conductive structure. The first electrode 110 may be further defined by its porosity. In one example, the first electrode 110 is about 20% to about 90% porosity. In another example, the first electrode 110 is about 25% to about 85% porosity. In yet another example, the first electrode 110 is about 30% to about 80% porosity. In a further example, the first electrode 110 is about 35% to about 75% porosity.

The first electrode 110 includes an electrochemically active material 162, such as immobilized sulfur 160, as defined by U.S. Pat. Application Publication No. 2021/0359290 which is incorporated herein by reference in its entirety. In one example, the first electrode 110 includes about 20 wt.% to about 99 wt.% immobilized sulfur 160. In another example, the first electrode 110 includes about 25 wt.% to about 90 wt.% immobilized sulfur 160. In one example, the first electrode 110 includes about 30 wt.% to about 85 wt.% immobilized sulfur 160.

The first electrode 110 may further include a binder 170. The binder 170 serves to maintain the electrode 110 physically intact, although other means may be implemented. In one example, the first electrode 110 includes about 0.2 wt. % to about 25.0 wt.% binder 170. In another example, the first electrode 110 includes about 0.5 wt. % to about 20.0 wt.% binder 170. In yet another example, the first electrode 110 includes about 1.0 wt. % to about 15.0 wt. % binder 170.

The binder 170 may include one or more of carboxymethyl cellulose, styrene-butadiene rubber, PVDF, PTFE, and PAA. In another example, the binder 170 includes about 0.2 wt.% to about 25 wt.% carboxymethyl cellulose and about 0.1 wt.% to about 13 wt.% styrene-butadiene rubber. In yet another example, the binder 170 includes about 0.5 wt.% to about 20.0 wt.% carboxymethyl cellulose and about 0.2 wt.% to about 10.0 wt.% styrene-butadiene rubber. In a further example, the binder 170 includes about 1.0 wt.% to about 15.0 wt.% carboxymethyl cellulose and about 0.5 wt.%-8.0 wt.% styrene-butadiene rubber.

The binder 170 may be characterized by a ratio of components. The ratio of components may be selected to achieve desired material properties, chemical properties, and physical properties, such as adhesion, elasticity, and flexibility. In one example, the binder 170 includes carboxymethyl cellulose and styrene-butadiene rubber at a ratio of 4:1. In another example, the binder 170 includes carboxymethyl cellulose and styrene-butadiene rubber at a ratio of 8:1. In yet another example, the binder 170 includes carboxymethyl cellulose and styrene-butadiene rubber at a ratio of 14:1.

The first electrode 110 may further include one or more materials including chalcogen element e.g., S, Se, O, and Te, fluoride, intercalated cathode material e.g., LiCoO₂, LiMnO₂, LiNiO₂, LiCoₓNiₓMn_{1-x-y}O₂, and LiFePO₄ that may include various dopants such as Ni, Mg, Al, Cr, Zn, Ti, Fe, Co, Ni, Cu, Nd, and La, and a supercapacitor material e.g., metal oxides/hydroxides, and conductive polymers.

The first electrode 110 may be further defined by a sulfur loading density, which may be referred to as “thickness”. For example, a thin electrode 110 may have a sulfur loading density of ≤ 1.5, ≤ 1.3, or ≤ 1.1 mg-S/cm². A medium thick electrode 110 may have a sulfur loading density of 1.1 to 5.5 mg-S/cm², 1.3 to 5.0 mg-S/cm², or 1.5-4.5 mg-S/cm². An ultra-thick electrode 110 may have a sulfur loading density of ≥ 5.5, ≥ 5.0, or ≥ 4.5 mg-S/cm².

In one example, the first electrode 110 has a S loading of about 0.6 mg-S/cm² to about 4.5 mg-S/cm². Greater than 0.2 mg-S/cm² in another example, the first electrode 110 has a S loading greater than 1.0 mg-S/cm², or in another example the first electrode 110 has a S loading greater than 2.0 mg-S/cm², or further the first electrode 110 has a S loading greater than 3.0 mg-S/cm². The first electrode 110 may be further defined by a sulfur content in loading. In one example, the sulfur content is ≥ 28 wt.%, ≥ 32 wt.%, or ≥ 36 wt.%.

The first electrode 110 may be further defined by coating thickness. A thin electrode 110 may be defined as having a coating thickness of ≤ 44 µm, a coating thickness of ≤ 36 µm, or a coating thickness of ≤ 28 µm. A medium thick electrode 110 may be defined as having a coating thickness of 28-145 µm, a coating thickness of 36-138 µm, or a coating thickness of 44-130 µm. An ultra-thick electrode 110 may be defined as having a coating thickness of ≥ 145 µm, a coating thickness of ≥ 138 µm, or a coating thickness of ≥ 130 µm.

The first electrode 110 may be further defined by coating density. In one example, the first electrode 110 is defined as having a low coating density of about 0.5 to about 0.8 g/cm³. In another example, the first electrode 110 is defined as having a medium coating density of about 0.8 to about 1.0 g/cm³. In yet another example, the first electrode 110 is defined as having a high coating density of ≥ 1.0 g/cm³.

The first electrode 110 may be further defined by specific capacity. In one example, the first electrode 110 may have a specific capacity of ≥ 700 mAh/g-S, ≥900 mAh/g-S, ≥ 1100 mAh/g-S. The first electrode 110 may be further defined by areal capacity. In one example, the first electrode 110 may have an areal capacity of ≥ 3 mAh/cm², ≥ 5 mAh/cm², ≥ 7 mAh/cm², or ≥ 9 mAh/cm². In yet a further aspect, the first electrode 110 may be defined by current density. In one example, the current density is ≥ 0.5 mA/cm², ≥ 0.9 mA/cm², ≥ 1.3 mA/cm², or ≥ 1.7 mA/cm². While there are ranges of examples listed above, it is understood that the first electrode 110 has the capability to perform at a lower current density than listed above.

The first electrode 110 further includes a porous composition 180. In one example, the first electrode 110 includes about 0.01 wt.% to about 50 wt.% a porous composition 180. In another example, the first electrode 110 includes about 0.1 wt.% to about 40 wt.% a porous composition 180. In yet another example, the first electrode 110 includes about 1 wt.% to about 30 wt.%, or about 2 wt.% to about 20 wt.% or even further about 0.2 wt.% to about 12 wt.% a porous composition 180. The porous composition 180 may be a blend of at least two porous, electrically conductive materials having different porosities. The porosity of each material included in the porous composition 180 is determined by mercury intrusion porosimetry and/or by Brunauer-Emmett-Teller (BET) Method.

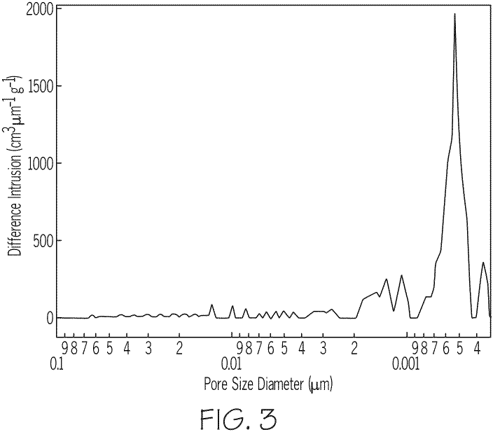

In one example, the porous composition 180 includes about 0.0001 wt.% to 40 wt.% of a first porous material 182 having an average pore size less of than 2 nm, see FIG. 3. In another example, the porous composition 180 includes about 0.001 wt.% to about 30 wt.% of a first porous material 182 having an average pore size less of than 2 nm. In yet another example, the porous composition 180 includes about 0.01 wt.% to about 20 wt.% of a first porous material 182 having an average pore size less of than 2 nm, or even further about 0.1 wt.% to about 10 wt.% of a first porous material 182 having an average pore size less of than 2 nm.

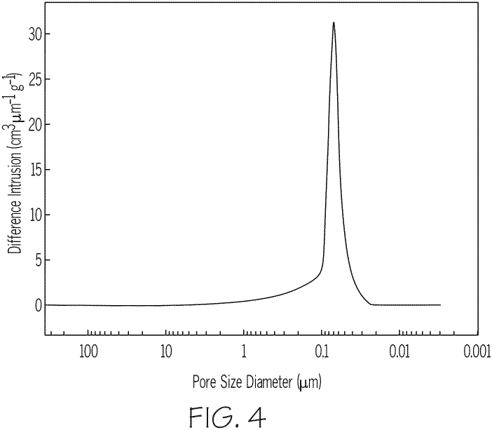

The porous composition 180 may further include about 0.05 wt.% to about 40 wt.% of a second porous material 184 having an average pore size of 2 nm to 100 nm, see FIG. 4, which illustrates about 0.003 µm to about 363 µm. In another example, the porous composition 180 includes about 0.1 wt.% to about 30 wt.% of a second porous material 184 having an average pore size of 2 nm to 100 nm. In yet another example, the porous composition 180 includes about 0.5 wt.% to about 20 wt.% of a second porous material 184 having an average pore size of 2 nm to 100 nm, or even further about 1 wt.% to about 15 wt.% of a second porous material 184 having an average pore size of 2 nm to 100 nm.

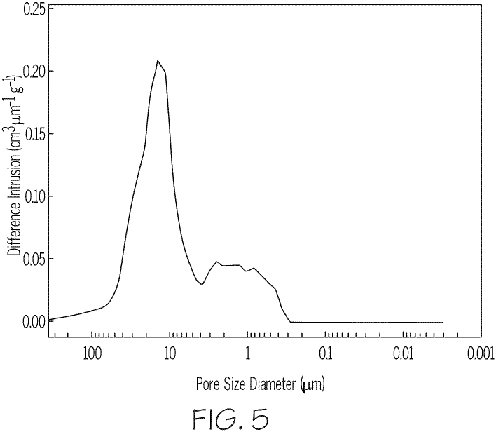

In one or more example, the porous composition 180 may further include a third porous material 186 having an average particle size ranging between 100 nm and 3 µm, see FIG. 5, showing 0.003 µm to about 363 µm. In one example, the porous composition 180 includes about 0.001 wt.% to about 20 wt.% of a third porous material 186 having an average pore size ranging between 100 nm and 3 µm. 0.01 wt.%-15 wt.%, 0.1 wt.%-10 wt.%, 0.2 wt.%-5 wt.%

In one or more example, the porous composition 180 may further include a fourth porous material 188 having an average particle size greater than 3 µm, see FIG. 5. in one example. In another example, the porous composition 180 includes about 0.001 wt.% to about 20 wt.% of a fourth porous material 188 having an average pore size greater than 3 µm. In yet another example, the porous composition 180 includes about 0.01 wt.% to about 15 wt.% of a fourth porous material 188 having an average pore size greater than 3 µm, or even further about 0.1 wt.% to about 10 wt.% of a fourth porous material 188 having an average pore size greater than 3 µm. In yet another example, the porous composition 180 includes about 0.2 wt.% to about 5 wt.% of a fourth porous material 188 having an average pore size greater than 3 µm.

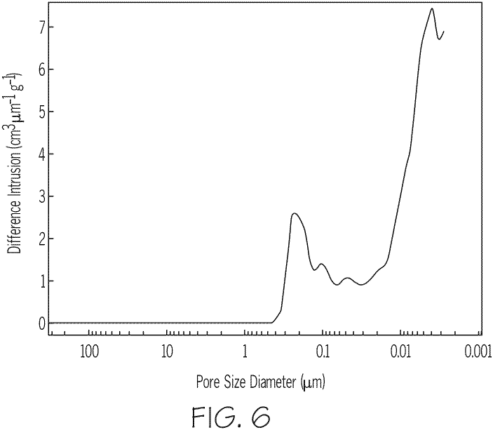

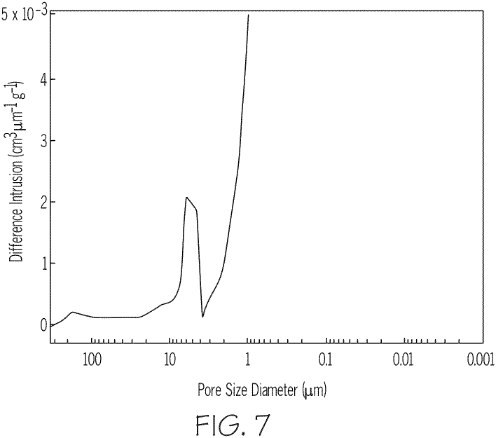

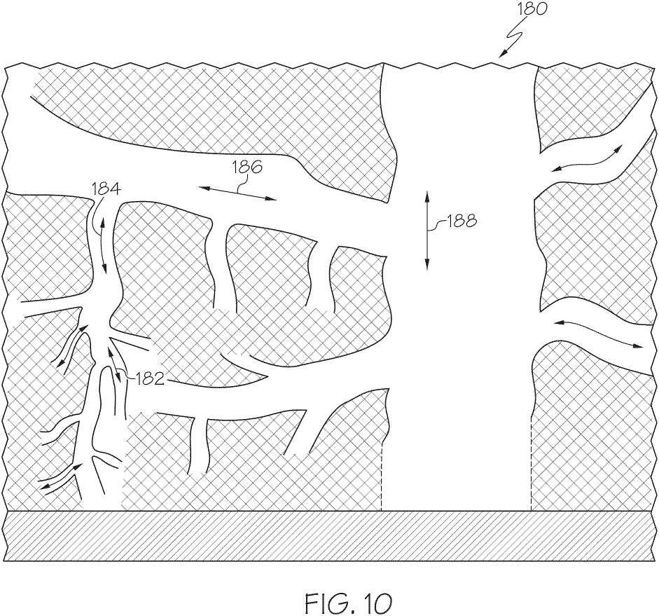

Referring to FIGS. 6 and 7, in one or more examples, illustrated is the pore size diameter distribution for a mixture of the porous composition 180 including all four porous materials 182, 184, 186, and 188. The pore size diameter distribution in the graph of FIG. 6 shows a distribution of a mixture including all four types of porous materials, and FIG. 7 is a graph showing the Y-axis expanded 1500 times of FIG. 6(182, 184, 186, and 188 - shown in FIG. 10). FIG. 10 is an additional schematic diagram of a mixture of all four types of porous materials, illustrating an ion transport system throughout a material of various porosities. It indicates three types of porous materials -first porous material 182 with a pore size of ~2 nanometer (nm) or smaller, second porous material 184 with a pore size of 2 nanometer (nm) to 100 nanometer (nm), and third porous material 186 with a pore size of 100 nanometer (nm) to 3 micrometer (µm). The graph of FIG. 7 shows with the fourth porous material 184 with a pore size of > 3 micrometer (µm) as observed when zoomed X 1500 along the y-axis. It is understood that the mixing process impacts the final pore size distribution of the porous composition 180 of the first electrode 110. Thus, the examples shown and described herein are variable and do not limit the scope of the disclosure. It is understood that the ranges disclosed herein may not be exactly followed by mathematic calculations of all four types of porous materials (182, 184, 186, and 188), and that the distribution varies based upon mixing parameters and other variables.

With respect to the porous composition 180, it is understood that one or more of the first porous material 182, second porous material 184, third porous material 186, or fourth porous material 188 includes one or more of activated carbon, carbon nanotubes, graphene, carbon molecular sieves, and hollow carbon fibers having different pore sizes. In another example, one or more of the first, second, third or fourth porous material includes one or more of a metal oxide e.g., silica, diatomaceous earth, alumina, ZrO₂, TiO₂, ZnO₂, aluminosilicate, a metal-organic framework, a porous polymeric resin, a sacrificial emulsion with a liquid or gas, and a natural porous material.

Referring back to FIG. 1 and FIG. 2, in one or more examples, the electrochemical device 100 includes a second electrode 120 opposed from the first electrode 110. In one example, the second electrode 120 is an anode 122, such as a lithium disc. The second electrode 120 may be any thickness needed for the intended application. In one example, the second electrode 120 has a thickness of 20 µm to 2 mm. In another example, the second electrode 120 has a thickness of 40 µm to 1 mm. In yet another example, the second electrode has a thickness of about 60 µm to about 500 µm, and even further the second electrode 120 may have a thickness of about 80 µm to about 400 µm.

The second electrode 120 may include one of element from group IVA e.g., C, Si, Sn, an element from group IIIA e.g., Al, a transition metal from group IB-VIIIB e.g., Zn, Cd, Ag, an alkaline earth metal from group IIA e.g., Mg, Ca, an alkali metal from group IA e.g., Li, Na, K, and a compound e.g., LiₓSi_{y}, LiₓGe_{y}, LiAl, LiₓSn_{y}, LTO, NiO, SiOₓ. In another example, the second electrode 120 includes lithium.

Still referring to FIG. 1, the electrochemical device 100 further includes an electrolyte 130 positioned between the first electrode 110 and the second electrode 120. Further, the electrolyte 130 wets or soaks the first electrode 110 and the second electrode 120, such that it serves to wet the cathode and anode. In one example, the electrolyte 130 comprises one or more of LiBF₄, LiC₂F₆NO₄S₂, LiN_{S}2O₄F₂, LiBOB, LiPO₂F₂, LiPF₆, ether, and carbonate. The electrolyte 130 may be a standard electrolyte used in coin cell batteries, such as disclosed in U.S. Pat. No. 11,114,696 which is incorporated herein by reference in its entirety.

Still referring to FIG. 2, in one or more examples, the electrochemical device may further include a separator 140 positioned between the first electrode 110 and the second electrode 120. In one example, the separator 140 includes polyolefin. In another example, the separate 140 includes one or more of polyethylene, polypropylene, and polybutylene. The separator 140 may have a thickness of about 5 µm to about 100 µm, or may be about 25 µm thick.

The electrochemical device 100 may be further characterized by cycle rate. The cycle rate represents how fast the electrochemical device 100 discharges and charges, such that a C-rate of 1 equates to 1 hour of discharge and charge time. The C-rate for discharge and charge may be different. In one example, the electrochemical device 100 has a cycle rate of about 0.25 C-rate to about 1 C-rate. In another example, the electrochemical device 100 has a capability of cycling at rate greater than or equal to 0.1 C, 0.5 C, and 1 C. It is further understood that the electrochemical device 100 shall have the capability to perform at a lower C-rate than within these specified ranges.

The cycle rate is dependent on the discharge current density. In one example, the discharge current density is greater than 0.4 mA/cm². In another example, the discharge current density is greater than 0.8 mA/cm². In yet another example, the discharge current density is greater than 1.2 mA/cm². It is further understood that the electrochemical device 100 shall have the capability to perform at a lower current density than within these specified ranges.

The electrochemical device 100 may further include additional components, including but not limited to a positive case 102, negative case 104, foil, such as lithium foil 126, a wave spring 190 or foam, such as Ni foam, and one or more spacers 124, as seen in FIG. 2. In another example, the electrochemical device 100 includes a negative tab and a positive tab, such as in a pouch cell. It is understood that other battery and electrochemical device 100 arrangements and configurations may be implemented with the disclosure.

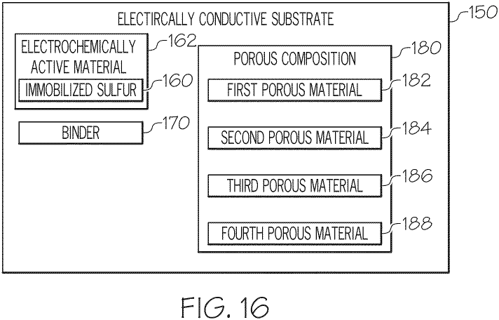

Referring to FIG. 16, also disclosed herein is an electrically conductive substrate 150 for an electrochemical device 100. In one example, the electrically conductive substrate 150 includes immobilized sulfur 160 as defined by U.S. Pat. Application Publication No. 2021/0359290 which is incorporated herein by reference in its entirety. In one example, the electrically conductive substrate 150 includes about 20 wt.% to about 99 wt.% immobilized sulfur 160. In another example, the electrically conductive substrate 150 includes about 25 wt.% to about 90 wt.% immobilized sulfur 160. In yet another example, immobilized sulfur 160 comprises about 30 wt.% to about 85 wt.% sulfur.

The electrically conductive substrate 150 further includes a binder 170. The binder 170 serves to maintain the electrode 110 physically intact, although other means may be implemented. In one example, the first electrode 110 includes about 0.2 wt. % to about 25.0 wt.% binder 170. In another example, the first electrode 110 includes about 0.5 wt. % to about 20.0 wt.% binder 170. In yet another example, the first electrode 110 includes about 1.0 wt. % to about 15.0 wt. % binder 170.

The binder 170 may include one or more of carboxymethyl cellulose, styrene-butadiene rubber, PVDF, PTFE, and PAA. In another example, the binder 170 includes about 0.2 wt.% to about 25 wt.% carboxymethyl cellulose and about 0.1 wt.% to about 13 wt.% styrene-butadiene rubber. In yet another example, the binder 170 includes about 0.5 wt.% to about 20.0 wt.% carboxymethyl cellulose and about 0.2 wt.% to about 10.0 wt.% styrene-butadiene rubber. In a further example, the binder 170 includes about 1.0 wt.% to about 15.0 wt.% carboxymethyl cellulose and about 0.5 wt.%-8.0 wt.% styrene-butadiene rubber.

The binder 170 may be characterized by a ratio of components. The ratio of components may be selected to achieve desired material properties, chemical properties, and physical properties, such as adhesion, elasticity, and flexibility. In one example, the binder 170 includes carboxymethyl cellulose and styrene-butadiene rubber at a ratio of 4:1. In another example, the binder 170 includes carboxymethyl cellulose and styrene-butadiene rubber at a ratio of 8:1. In yet another example, the binder 170 includes carboxymethyl cellulose and styrene-butadiene rubber at a ratio of 14:1.

The electrically conductive substrate 150 may further include one or more materials including chalcogen element e.g., S, Se, O, Te, fluoride, intercalated cathode material e.g., LiCoO₂, LiMnO₂, LiNiO₂, LiCoₓNiₓMn_{1-x-y}O₂, LiFePO₄ various dopants such Ni, Mg, Al, Cr, Zn, Ti, Fe, Co, Ni, Cu, Nd, and La, and a supercapacitor material e.g., metal oxides/hydroxides, and conductive polymers.

The electrically conductive substrate 150 may be further defined by a sulfur loading density, which may be referred to as “thickness”. For example, a thin electrode 110 may have a sulfur loading density of ≤ 1.5, ≤ 1.3, or ≤ 1.1 mg-S/cm². A medium thick electrode 110 may have a sulfur loading density of 1.1 to 5.5 mg-S/cm², 1.3 to 5.0 mg-S/cm², or 1.5-4.5 mg-S/cm². An ultra-thick electrode 110 may have a sulfur loading density of ≥ 5.5, ≥ 5.0, or ≥ 4.5 mg-S/cm².

In one example, the electrically conductive substrate 150 has a S loading of about 0.6 mg-S/cm² to about 4.5 mg-S/cm². Greater than 0.2 mg-S/cm² in another example, the electrically conductive substrate 150 has a S loading greater than 1.0 mg-S/cm², or in another example the electrically conductive substrate 150 has a S loading greater than 2.0 mg-S/cm², or further the electrically conductive substrate 150 has a S loading greater than 3.0 mg-S/cm².

The electrically conductive substrate 150 may be further defined by a sulfur content in loading. In one example, the sulfur content is ≥ 28 wt%, ≥ 32 wt%, or ≥ 36 wt%.

The electrically conductive substrate 150 may be further defined by coating thickness. A thin electrode 110 may be defined as having a coating thickness of ≤ 44 µm, a coating thickness of ≤ 36 µm, or a coating thickness of ≤ 28 µm. A medium thick electrode 110 may be defined as having a coating thickness of 28-145 µm, a coating thickness of 36-138 µm, or a coating thickness of 44-130 µm. An ultra-thick electrode 110 may be defined as having a coating thickness of ≥ 145 µm, a coating thickness of ≥ 138 µm, or a coating thickness of ≥ 130 µm.

The electrically conductive substrate 150 may be further defined by coating density. In one example, the electrically conductive substrate 150 is defined as having a low coating density of about 0.5 to about 0.8 g/cm³. In another example, the electrically conductive substrate 150 is defined as having a medium coating density of about 0.8 to about 1.0 g/cm³. In yet another example, the electrically conductive substrate 150 is defined as having a high coating density of ≥ 1.0 g/cm³.

The electrically conductive substrate 150 may be further defined by specific capacity. In one example, the electrically conductive substrate 150 may have a specific capacity of ≥ 700 mAh/g-S, ≥ 900 mAh/g-S, or ≥ 1100 mAh/g-S. The electrically conductive substrate 150 may be further defined by areal capacity. In one example, the electrically conductive substrate 150 may have an areal capacity of ≥ 3 mAh/cm², ≥ 5 mAh/cm², ≥ 7 mAh/cm², or ≥ 9 mAh/cm². In yet a further aspect, the electrically conductive substrate 150 may be defined by current density. In one example, the current density is ≥ 0.5 mA/cm², ≥ 0.9 mA/cm², ≥ 1.3 mA/cm², or ≥ 1.7 mA/cm². It is understood that the electrically conductive substrate 150 shall have the capability to perform at lower current densities than specified in the ranges above.

The electrically conductive substrate 150 further includes a porous composition 180. In one example, the first electrode 110 includes about 0.01 wt.% to about 50 wt.% a porous composition 180. In another example, the first electrode 110 includes about 0.1 wt.% to about 40 wt.% a porous composition 180. In yet another example, the first electrode 110 includes about 1 wt.% to about 30 wt.%, or about 2 wt.% to about 20 wt.% or even further about 0.2 wt.% to about 12 wt.% a porous composition 180. The porous composition 180 may be a blend of at least two porous, electrically conductive materials having different porosities. The porosity of each material included in the porous composition 180 is determined by mercury intrusion porosimetry and/or by Brunauer-Emmett-Teller (BET) Method.

In one example, the porous composition 180 includes about 0.0001 wt.% to 40 wt.% of a first porous material 182 having an average pore size less of than 2 nm. In another example, the porous composition 180 includes about 0.001 wt.% to about 30 wt.% of a first porous material 182 having an average pore size less of than 2 nm. In yet another example, the porous composition 180 includes about 0.01 wt.% to about 20 wt.% of a first porous material 182 having an average pore size less of than 2 nm, or even further about 0.1 wt.% to about 10 wt.% of a first porous material 182 having an average pore size less of than 2 nm.

The porous composition 180 may further include about 0.05 wt.% to about 40 wt.% of a second porous material 184 having an average pore size of 2 nm to 100 nm. In another example, the porous composition 180 includes about 0.1 wt.% to about 30 wt.% of a second porous material 184 having an average pore size of 2 nm to 100 nm. In yet another example, the porous composition 180 includes about 0.5 wt.% to about 20 wt.% of a second porous material 184 having an average pore size of 2 nm to 100 nm, or even further about 1 wt.% to about 15 wt.% of a second porous material 184 having an average pore size of 2 nm to 100 nm.

In one or more example, the porous composition 180 may further include a third porous material 186 having an average particle size ranging between 100 nm and 3 µm. In one example, the porous composition 180 includes about 0.001 wt.% to about 20 wt.% of a third porous material 186 having an average pore size ranging between 100 nm and 3 µm. In another example, the porous composition 180 includes about 0.01 wt.% to about 15 wt.% of a third porous material 186 having an average pore size ranging between 100 nm and 3 µm. In yet another example, the porous composition 180 includes about 0.1 wt.% to about 10 wt.% of a third porous material 186 having an average pore size ranging between 100 nm and 3 µm, and in a further example the porous composition 180 includes about 0.2 wt.% to about 5 wt.% of a third porous material 186 having an average pore size ranging between 100 nm and 3 µm

In one or more example, the porous composition 180 may further include a fourth porous material 188 having an average particle size greater than 3 µm. In another example, the porous composition 180 includes about 0.001 wt.% to about 20 wt.% of a fourth porous material 188 having an average pore size greater than 3 µm. In yet another example, the porous composition 180 includes about 0.01 wt.% to about 15 wt.% of a fourth porous material 188 having an average pore size greater than 3 µm, or even further about 0.1 wt.% to about 10 wt.% of a fourth porous material 188 having an average pore size greater than 3 µm. In yet another example, the porous composition 180 includes about 0.2 wt.% to about 5 wt.% of a fourth porous material 188 having an average pore size greater than 3 µm.

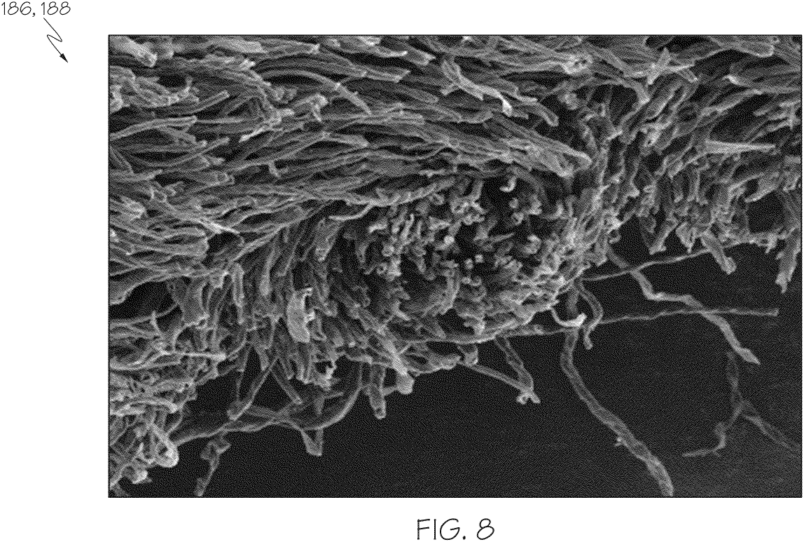

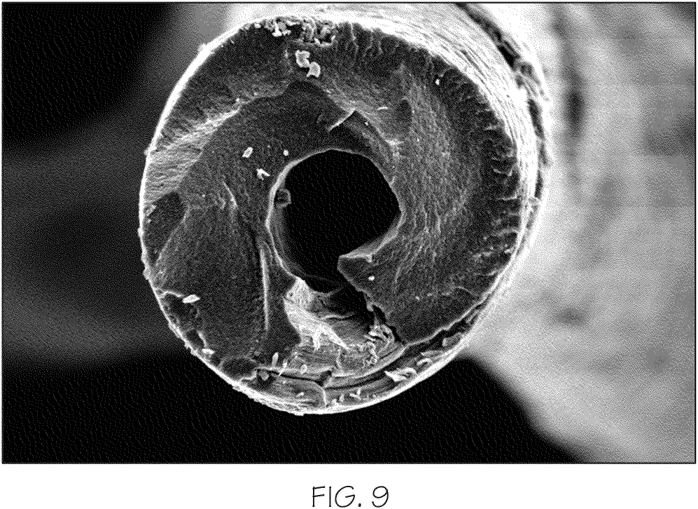

With respect to the porous composition 180, it is understood that one or more of the first, second, third or fourth porous material 188 includes one or more of activated carbon, carbon nanotubes, graphene, carbon molecular sieves, and hollow carbon fibers having different pore sizes. In another example, one or more of the first, second, third or fourth porous material 188 includes one or more of a metal oxide e.g., silica, diatomaceous earth, alumina, ZrO₂, TiO₂, ZnO₂, aluminosilicate, a metal-organic framework, a porous polymeric resin, a sacrificial emulsion with a liquid or gas, and a natural porous material. SEM images of an exemplary porous composition 180 can be seen in FIG. 8 and FIG. 9.

Other non-limiting examples or aspects are set forth in the following illustrative and exemplary numbered clauses:

Clause 1. An electrochemical device comprising: a first electrode 110 comprising 50 wt.% to 99 wt.% immobilized sulfur 160; 1 wt. % to 12 wt.% binder 170; and 0.2 wt.% to 12 wt.% porous composition 180 comprising: 0.0001 wt.% to 40 wt.% of a first porous material 182 having an average pore size less of than 2 nm; and 0.05 wt.% to 40 wt.% of a second porous material 184 having an average pore size of 2 nm to 100 nm a second electrode 120 opposed from the first electrode 110; and an electrolyte 130 positioned between the first electrode 110 and the second electrode 120.

Clause 2. The electrochemical device 100 of clause 1, wherein the porous composition 180 further comprises about 0.001 wt.% to about 20 wt.% of a third porous material 186 having an average pore size ranging between 100 nm and 3 µm.

Clause 3. The electrochemical device 100 of any one of clauses 1-2, wherein the porous composition 180 further comprises about 0.001 wt.% to about 20 wt.% of a fourth porous material 188 having an average pore size greater than 3 µm.

Clause 4. The electrochemical device 100 of any one of clauses 1-3, wherein the first electrode 110 comprises one of chalcogen element, fluoride, intercalated cathode material, and a supercapacitor material.

Clause 5. The electrochemical device 100 of any one of clauses 1-4, where in the second electrode 120 comprises one of element from group IVA, an element from group IIIA, a transition metal from group IB-VIIIB, an alkaline earth metal from group IIA, an alkali metal from group IA, and a compound.

Clause 6. The electrochemical device 100 of any one of clauses 1-5, wherein one or more of the first porous material 182, second porous material 184, third porous material 186 or fourth porous material 188 comprises one or more of activated carbon, carbon nanotubes, graphene, carbon molecular sieves, and hollow carbon fibers.

Clause 7. The electrochemical device 100 of any one of clause 1-6, wherein one or more of the first porous material 182, second porous material 184, third porous material 186 or fourth porous material 188 comprises one or more of a metal oxide, a metal-organic framework, a porous polymeric resin, a sacrificial emulsion with a liquid or gas, and a natural porous material.

Clause 8. The electrochemical device 100 of any one of clauses 1-7, wherein the second electrode 120 has a thickness of 20 µm to 2 mm.

Clause 9. The electrochemical device 100 of any one of clauses 1-8, wherein the second electrode 120 comprises lithium.

Clause 10. The electrochemical device 100 of any one of clauses 1-9, wherein the electrolyte 130 comprises one or more of LiBF₄, LiC₂F₆NO₄S₂, LiNS₂O₄F₂, LiBOB, LiPO₂F₂, LiPF₆, ether, and carbonate.

Clause 11. The electrochemical device 100 of any one of clauses 1-10, wherein the first electrode 110 has a S loading of about 0.6 mg-S/cm² to about 4.5 mg-S/cm².

Clause 12. The electrochemical device 100 of any one of clauses 1-11, wherein the binder 170 comprises one or more of carboxymethyl cellulose, styrene-butadiene rubber, PVDF, PTFE, and PAA.

Clause 13. The electrochemical device 100 of any one of clauses 1-12, wherein the binder 170 comprises one or more of about 0.2 wt.% to about 25 wt.% carboxymethyl cellulose and about 0.01 wt.% to about 13 wt.% styrene-butadiene rubber.

Clause 14. The electrochemical device 100 of any one of clauses 1-13, wherein the immobilized sulfur 160 comprises about 20 wt.% to about 95 wt.% sulfur.

Clause 15. The electrochemical device 100 of any one of clauses 1-14 having a cycle rate of about 0.25 C-rate.

Clause 16. The electrochemical device 100 of any one of clauses 1-15 having a discharge current density greater than 0.4 mA/cm².

Clause 17. The electrochemical device 100 of any one of clauses 1-16, further comprising a separator 140 positioned between the first electrode 110 and the second electrode 120.

Clause 18. The electrochemical device 100 of any one of clauses 1-17, wherein the separator 140 comprises polyolefin.

Clause 19. An electrically conductive substrate for an electrochemical device 100 comprising: 50 wt.% to 99 wt.% immobilized sulfur 160; 1 wt. % to 12 wt.% binder 170; and 0.2 wt.% to 12 wt.% porous composition 180 comprising: 0.0001 wt.% to 40 wt.% of a first porous material 182 having an average pore size less of than 2 nm; and 0.05 wt.% to 40 wt.% of a second porous material 184 having an average pore size of 2 nm to 100 nm.

Clause 20. The electrically conductive substrate of clause 19, wherein the immobilized sulfur 160 comprises about 20 wt.% to about 95 wt.% sulfur.

Clause 21. The electrically conductive substrate 150 of any one of clauses 19-20, wherein one or more of the first porous material 182 and the second porous material 184 comprises one or more of activated carbon, carbon nanotubes, graphene, carbon molecular sieves, and hollow carbon fibers.

Clause 22. The electrically conductive substrate 150 of any one of clauses 19-21, wherein one or more of the first porous material 182 and the second porous material 184 comprises one or more of a metal oxide, a metal-organic framework, a porous polymeric resin, a sacrificial emulsion with a liquid or gas, and a natural porous material.

Clause 23. The electrically conductive substrate 150 of any one of clauses 19-22, wherein the porous composition 180 further comprises a third porous material 186 having an average pore size above 100 nm.

Clause 24. A cathode 112 comprising the electrically conductive substrate 150 of any one of clauses 19-23.

Clause 25. An anode 122 comprising the electrically conductive substrate 150 of any one of clauses 19-23.

### EXAMPLES

The following examples illustrate the relationship of porosity of the materials used in the electrically conductive substrate 150, first electrode 110, and second electrode 120. By selectively controlling porosity and thickness of the electrically conductive substrate 150, first electrode 110, and second electrode 120, it is possible to achieve improved cycle rate and performance of electrochemical devices 100.

For the examples disclosed herein, the material used for the porous composition 180 (including the third porous material 186 and the fourth porous material 188) of the first electrode 110 was a natural cotton textile prepared by a pyrolysis process. Cotton fiber textile was put into a quartz tube reactor (2-in diameter) under a stream of argon flow at 1.5 Liter/min. The sample was purged with argon at room temperatures for 30 mins. After purging, the furnace was ramped to 1000° C. in 3 hours and 20 minutes and soaked at 1000° C. for one hour. The sample was cooled down under a continuing flow of argon inside the reactor. The sample was then unloaded from the quartz reactor and was soaked in DI water for about 1 hour, wherein the soaked water was decanted; this soaking and decanting process was repeated for about 5 times. Then the washed sample was dried in an oven at 80° C. overnight before uses. As shown in the SEM images of FIGS. 8 and 9, the carbon of the mixture of the third porous material 186 (FIG. 10) and the fourth porous material 188 (FIG. 10) showed an internal hollow tube structure, having pore size distributions of 0.28 to 3.7 µm, centered at 1.3 µm, and 3.7 to 363 µm, centered at 14 µm.

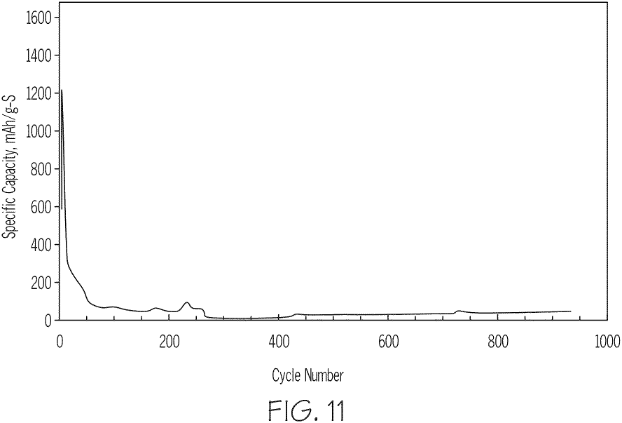

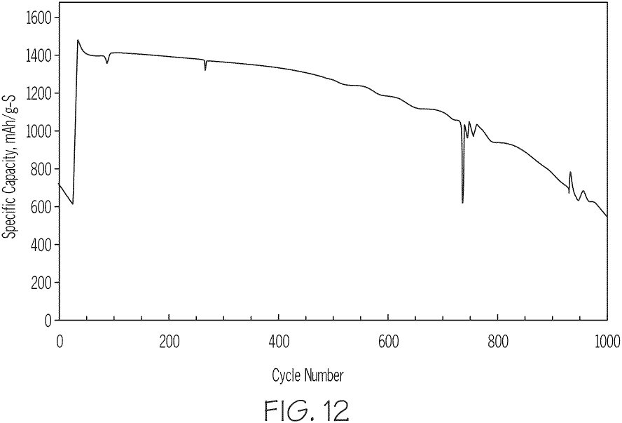

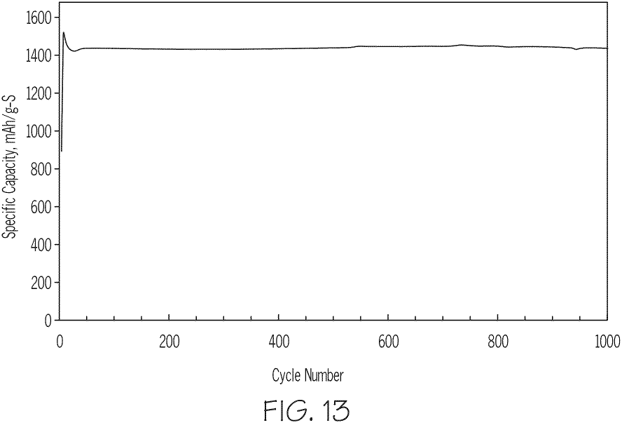

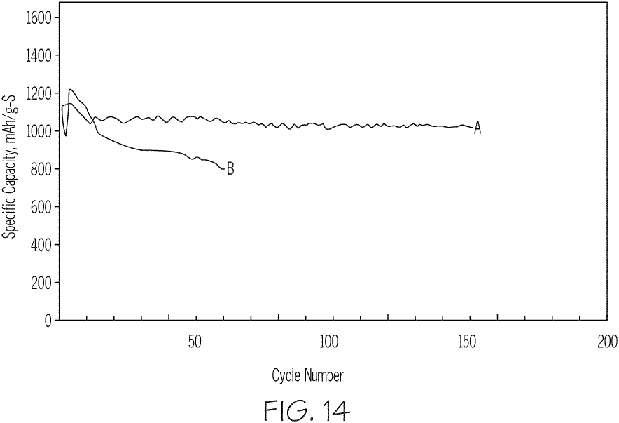

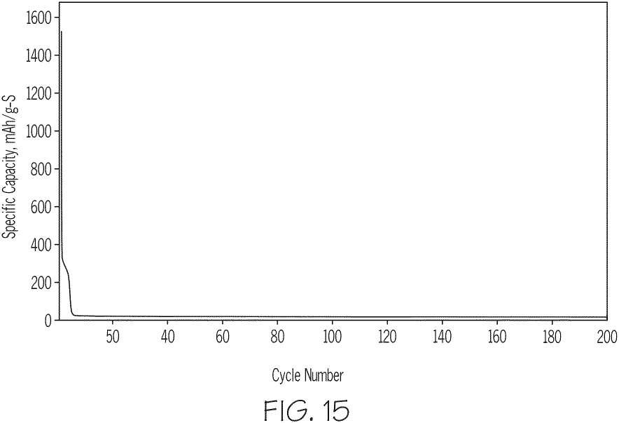

FIG. 11 correlates to the composition as shown in TABLE 1, FIG. 12 correlates to the composition as shown in TABLE 2, FIG. 13 correlates to the composition as shown in TABLE 3, FIG. 14, plots A and B, correlate to the compositions as shown in TABLES 4A and 4B, and FIG. 15 correlates to the composition as shown in TABLE 5.

TABLE 1

| | | | Weight, g | Solid wt% | Ratio/% |
|---|---|---|---|---|---|
| S-C Composite | | | 2.50 | 90 | |
| Binder | | CMC | 0.21 | 9.3 | 4 |
| | | SBR | 0.052 | | 1 |
| Porous composition 180 | First porous material 182 | | 0.01840 | 0.66 | 100 |
| | Second porous material 184 | | 0 | 0 | 0 |
| | Third porous material 186 and fourth porous material 188 | | 0 | 0 | 0 |

TABLE 2

| | | | Weight, g | Solid wt% | Ratio/% |
|---|---|---|---|---|---|
| S-C Composite | | | 2.50 | 81 | |
| Binder | | CMC | 0.21 | 8.4 | 4 |
| | | SBR | 0.052 | | 1 |
| Porous composition 180 | First porous material 182 | | 0 | 0 | 0 |
| | Second porous material 184 | | 0.31 | 10 | 100 |
| | Third porous material 186 and fourth porous material 188 | | 0 | 0 | 0 |

TABLE 3

| | | | Weight, g | Solid wt% | Ratio/% |
|---|---|---|---|---|---|
| S-C Composite | | | 2.50 | 81 | |
| Binder | | CMC | 0.21 | 8.8 | 4 |
| | | SBR | 0.052 | | 1 |
| Porous composition 180 | First porous material 182 | | 0.0092 | 0.30 | 2.9 |
| | Second porous material 184 | | 0.31 | 10 | 97 |
| | Third porous material 186 and fourth porous material 188 | | 0 | 0 | 0 |

TABLE 4A

| | | | Weight, g | Solid wt% | Ratio/% |
|---|---|---|---|---|---|
| S-C Composite | | | 12.5 | 81 | |
| Binder | | CMC | 1.10 | 8.0 | 8 |
| | | SBR | 0.13 | | 1 |
| Porous composition 180 | First porous material 182 | | 0.046 | 0.30 | 2.7 |
| | Second porous material 184 | | 1.6 | 10 | 90 |
| | Third porous material 186 and fourth porous material 188 | | 0.13 | 0.84 | 7.5 |
| Dipropylene Glycol Dimethyl Ether | | | 2.5 | | |

TABLE 4B

| | | | Weight, g | Solid wt% | Ratio/% |
|---|---|---|---|---|---|
| S-C Composite | | | 12.5 | 81 | |
| Binder | | CMC | 1.10 | 8.8 | 4 |
| | | SBR | 0.26 | | 1 |
| Porous composition 180 | First porous material 182 | | 0.046 | 0.30 | 2.9 |
| | Second porous material 184 | | 1.6 | 10 | 97 |
| | Third porous material 186 and fourth porous material 188 | | 0 | 0 | 0 |
| Dipropylene Glycol Dimethyl Ether | | | 3.0 | | |

TABLE 5

| | | | Weight, g | Solid wt% | Ratio/% |
|---|---|---|---|---|---|
| S-C Composite | | | 2.50 | 90 | |
| Binder | | CMC | 0.22 | 8.9 | 14 |
| | | SBR | 0.026 | | 1 |
| Porous composition 180 | First porous material 182 | | 0 | 0 | 0 |
| | Second porous material 184 | | 0 | 0 | 0 |
| | Third porous material 186 and fourth porous material 188 | | 0.026 | 0.94 | 100 |

As shown in the tables above and illustrated in FIGS. 11-17, the following observations were made. An electrochemical device 100, or battery, having a thin electrode as described herein including only first porous material 182 (TABLE 1, FIG. 11) exemplified a poor cycling performance. An electrochemical device 100, or battery, having a thin electrode as described herein including only second porous material 184 (TABLE 2, FIG. 12) exemplified a slow fade in specific capacity. An electrochemical device 100, or battery, having a thin electrode as described herein including both first porous material 182 and second porous material 184 (TABLE 3, FIG. 14) cycled well (≥1,000 cycles) without an observable fade in specific capacity. An electrochemical device 100, or battery, having a thick electrode as described herein including both third porous material 186 and fourth porous material 188 (TABLE 5, FIG. 15) exhibited a boost in its specific capacity by about 100 mAh/g-S for a battery with a thick cathode (4.4 mg-S/cm²).

Further, as seen in the figures, a battery made with a thin carbon-based cathode of solely the first porous material 182 did not cycle well. FIG. 11 depicts the cycling performance (1 C-Rate) for a thin cathode exhibiting the first porous material 182 level transport of less than 2 nm.

An improvement is recognized by using instead a thin cathode having the second porous material 184 ion transport system. While having an improvement in cycles at the 1 C-Rate, it did have a slow fade in specific capacity, as evident by the plot of FIG. 12.

A battery made with a thin cathode having both the first porous material 182 and second porous material 184 ion transport components did cycle well (e.g., greater than 1000 cycles) without an observable fade in specific capacity. FIG. 13 is a plot showing this capability, where a thin cathode comprised 0.3 wt.% the first porous material 182 and 10 wt.% the second porous material 184.

A thick cathode may comprise an ion transport system having the third porous material 186 and the fourth porous material 188, which boosted its specific capacity by about 100 mAh/g-S. FIG. 14 is a graph of a coin cell battery cycling performances (0.2 C-Rate) for a thick cathode (4.4 mg-S/cm²) with 0.3 wt.% the first porous material 182 and 10 wt.% the second porous material 184.. Plot “a” is for the particular case where in addition to the first porous material 182 and the second porous material 184, the porous composition 180 also includes the third porous material 186 and the fourth porous material 188. Plot “b” illustrates the results when excluding the third porous material 186 and the fourth porous material 188.

Although various examples of the disclosed electrochemical device and electrically conductive substrate have been shown and described, modifications may occur to those skilled in the art upon reading the specification. The present application includes such modifications and is limited only by the scope of the claims.

What is claimed is:

1. An electrochemical device comprising:
a first electrode comprising
50 wt.% to 99 wt.% immobilized sulfur;
1 wt. % to 12 wt.% binder; and
0.2 wt.% to 12 wt.% porous composition comprising:
0.0001 wt.% to 40 wt.% of a first porous material having an average pore size less of than 2 nm; and
0.05 wt.% to 40 wt.% of a second porous material having an average pore size of 2 nm to 100 nm
a second electrode opposed from the first electrode; and
an electrolyte positioned between the first electrode and the second electrode.

2. The electrochemical device of claim 1, wherein the porous composition further comprises about 0.001 wt.% to about 20 wt.% of a third porous material having an average pore size ranging between 100 nm and 3 µm.

3. The electrochemical device of claim 2, wherein the porous composition further comprises about 0.001 wt.% to about 20 wt.% of a fourth porous material 188 having an average pore size greater than 3 µm.

4. The electrochemical device of claim 1, wherein the first electrode comprises one of chalcogen element, fluoride, intercalated cathode material, and a supercapacitor material.

5. The electrochemical device of claim 1, where in the second electrode comprises one of element from group IVA, an element from group IIIA, a transition metal from group IB-VIIIB, an alkaline earth metal from group IIA, an alkali metal from group IA, and a compound.

6. The electrochemical device of claim 3, wherein one or more of the first porous material, second porous material, third porous material or fourth porous material comprises one or more of activated carbon, carbon nanotubes, graphene, carbon molecular sieves, and hollow carbon fibers.

7. The electrochemical device of claim 3, wherein one or more of the first porous material, second porous material, third porous material or fourth porous material comprises one or more of a metal oxide, a metal-organic framework, a porous polymeric resin, a sacrificial emulsion with a liquid or gas, and a natural porous material.

8. The electrochemical device of claim 1, wherein the second electrode has a thickness of 20 µm to 2 mm.

9. The electrochemical device of claim 1, wherein the second electrode comprises lithium.

10. The electrochemical device of claim 1, wherein the electrolyte comprises one or more of LiBF₄, LiC₂F₆NO₄S₂, LiNS₂O₄F₂, LiBOB, LiPO₂F₂, LiPF₆, ether, and carbonate.

11. The electrochemical device of claim 1, wherein the first electrode has a S loading of about 0.6 mg-S/cm² to about 4.5 mg-S/cm².

12. The electrochemical device of claim 1, wherein the binder comprises one or more of carboxymethyl cellulose, styrene-butadiene rubber, PVDF, PTFE, and PAA.

13. The electrochemical device of claim 1, wherein the binder comprises one or more of about 0.2 wt.% to about 25 wt.% carboxymethyl cellulose and about 0.01 wt.% to about 13 wt.% styrene-butadiene rubber.

14. The electrochemical device of claim 1, wherein the immobilized sulfur comprises about 20 wt.% to about 95 wt.% sulfur.

15. The electrochemical device of claim 1 having a cycle rate of about 0.25 C-rate.

16. The electrochemical device of claim 1 having a discharge current density greater than 0.4 mA/cm².

17. The electrochemical device of claim 1, further comprising a separator positioned between the first electrode and the second electrode.

18. The electrochemical device of claim 17, wherein the separator comprises polyolefin.

19. An electrically conductive substrate for an electrochemical device comprising:
50 wt.% to 99 wt.% immobilized sulfur;
1 wt. % to 12 wt.% binder; and
0.2 wt.% to 12 wt.% porous composition comprising:
0.0001 wt.% to 40 wt.% of a first porous material having an average pore size less of than 2 nm; and
0.05 wt.% to 40 wt.% of a second porous material having an average pore size of 2 nm to 100 nm.

20. The electrically conductive substrate of claim 19, wherein the immobilized sulfur comprises about 20 wt.% to about 95 wt.% sulfur.

21. The electrically conductive substrate of claim 19, wherein one or more of the first porous material and the second porous material comprises one or more of activated carbon, carbon nanotubes, graphene, carbon molecular sieves, and hollow carbon fibers.

22. The electrically conductive substrate of claim 19, wherein one or more of the first porous material and the second porous material comprises one or more of a metal oxide, a metal-organic framework, a porous polymeric resin, a sacrificial emulsion with a liquid or gas, and a natural porous material.

23. The electrically conductive substrate of claim 19, wherein the porous composition further comprises a third porous material having an average pore size above 100 nm.

24. A cathode comprising the electrically conductive substrate of claim 19.

25. An anode comprising the electrically conductive substrate of claim 19.
